(19) United States
(12) Patent Application Publication
(10) Pub. No.: US 2015/0366729 A1
(43) Pub. Date: Dec. 24, 2015

(54) Elevator Chair

(71) Applicant: Immanuel Lutheran School, Loveland, CO (US)

(72) Inventors: Keith Wesley Quick, Loveland, CO (US); Kendrick Wesley Quick, Loveland, CO (US); Cynthia Ann Poole Reeves, Loveland, CO (US); Theodore Spencer Reeves, Loveland, CO (US); Henry Jacob Brouwer, Johnstown, CO (US); Matthew Lander Yannutz, Berthoud, CO (US); Peter Thomas Scheller, Fort Collins, CO (US); Dustin Thomas Hanes, Loveland, CO (US); Andrew Scott Yee, Loveland, CO (US); Brian Alexander Yee, Loveland, CO (US); Jeoffrey Douglas Zerbst, Windsor, CO (US)

(21) Appl. No.: 14/147,642

(22) Filed: Jan. 6, 2014

Related U.S. Application Data
(60) Provisional application No. 61/750,317, filed on Jan. 8, 2013.
(60) Provisional application No. 61/777,007, filed on Mar. 12, 2013.

(51) Int. Cl. A61G 5/10; A61G 5/04; A47C 7/50; A47C 3/20; A47C 7/00

(52) U.S. Cl. CPC A61G 5/1059; A47C 3/20; A47C 7/002; A47C 7/506; A61G 5/04

(57) ABSTRACT

Described are chairs having a seat with a sitting location above the floor, a base that sits on a floor, a lift connecting the seat and the base, the lift capable of moving the seat up and down from the sitting location to a lower location at the floor, and a control system operating the lift. The control system allows an occupant of the chair to move the seat between its sitting location and the lower location at the floor to enable the occupant to pick up or place an item on the floor while sitting in the chair and thereafter to move the seat upwardly.

### RELATED APPLICATIONS

This application claims priority to and the benefit of U.S. provisional application No. 61/750,317, filed on Jan. 8, 2013, and to U.S. provisional application No. 61/777,007, filed on Mar. 12, 2013, the entireties of which applications are incorporated by reference herein.

### FIELD OF THE INVENTION

This invention relates to an elevator chair, where the seat is moveable from a sitting position to lower positions effective to permit an occupant sitting in the chair to pick up an item from the floor or place an item on the floor and then return to a higher sitting position.

### BACKGROUND

There is a need for specialty chairs to help people, such as seniors and people with disabilities. There are various specialty chairs that help such people get up out of them. These lift or tip the chair or its seat to assist a person sitting in the chair to get into a standing position. U.S. Pat. No. 7,926,876 discloses an example of such a chair. A jack, such as a scissor jack, raises the back or rear of the chair to help the occupant get up and out of the chair. U.S. Pat. No. 5,094,508 discloses another example of such a chair. In this U.S. patent, the back of the chair raises and lowers. When the back is raised, the chair's seat is tilted to assist the occupant to get up and out of the chair.

### SUMMARY

An elevator chair in accordance with the invention comprises a seat with a sitting location above the floor, a base that sits on the floor, and a lift connecting the seat and the base. The lift is capable of moving the seat from the sitting location to lower locations. The chair also includes a control system operating the lift that allows an occupant in the chair to move the seat between its sitting location and the lower location at the floor to enable the occupant to pick up or place an item on the floor while sitting in the chair and thereafter to move the seat upwardly.

In another aspect, the invention features an elevator chair comprising a seat with an upright back, a support that rests on a floor; and a lift that connects the seat to the support. The lift is adapted to move the seat up and down with respect to the floor between a sitting location above the floor and a lower location within approximately eight inches of the floor.

In still another embodiment, the invention features a chair comprising a seat with a sitting location above the floor, a base that sits on a floor, and a lift connecting the seat and the base. The lift is capable of moving the seat up and down from the sitting location to a lower location at the floor. A control system operates the lift. The control system allows an occupant of the chair to move the seat between its sitting location and the lower location at the floor to enable the occupant to pick up or place an item on the floor while sitting in the chair and thereafter to move the seat upwardly.

### BRIEF DESCRIPTION OF THE FIGURES

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a perspective view of an embodiment of the elevator chair with a motorized lift.

FIG. 2 is a rear elevation view of the elevator chair illustrated in FIG. 1, but showing batteries, controls and arm rests.

FIG. 3 is a schematic of the power and controls of the elevator chair in FIG. 1 and FIG. 2.

FIG. 4A is a simplified side elevation view of the elevator chair illustrated in FIG. 1 with the seat in its upper sitting location.

FIG. 4B is a simplified side elevation view of the elevator chair illustrated in FIG. 4A with the seat in a lower location.

FIG. 4C is a simplified side elevation view of the elevator chair illustrated in FIG. 4A with the seat in a lower location than illustrated in FIG. 4B.

FIG. 4D is a simplified side elevation view of the elevator chair illustrated in FIG. 4A with the seat at floor.

FIG. 5 is a simplified side elevation view of an alternate embodiment of an elevator chair using a bellows as a lift.

FIG. 6 is a simplified side elevation view of an alternate embodiment of an elevator chair using a rack and pinion as a lift.

FIG. 7 is a simplified side elevation view of an alternate embodiment of an elevator chair using a spring as a lift.

### DETAILED DESCRIPTION

It is desirable to have a chair that could help seniors and people with disabilities or with other vexing problems to retrieve from the floor or putting things on the floor while seated, to retrieve or place items in a low cupboard such as in the kitchen, to work on wiring under a computer table, to retrieve a dropped item or feed a pet. Many tasks in daily life require working at a level below that of a seated person. A typical individual would kneel down to do these tasks. Aging, arthritis and knee replacement surgeries prevent people from being able to kneel and perform these tasks. That is an aim of the elevator chairs described herein.

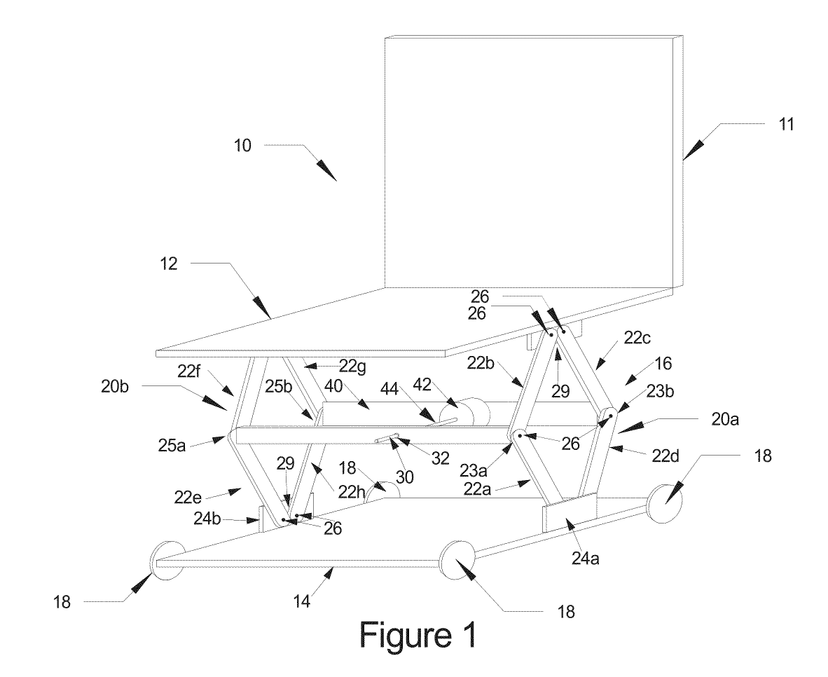

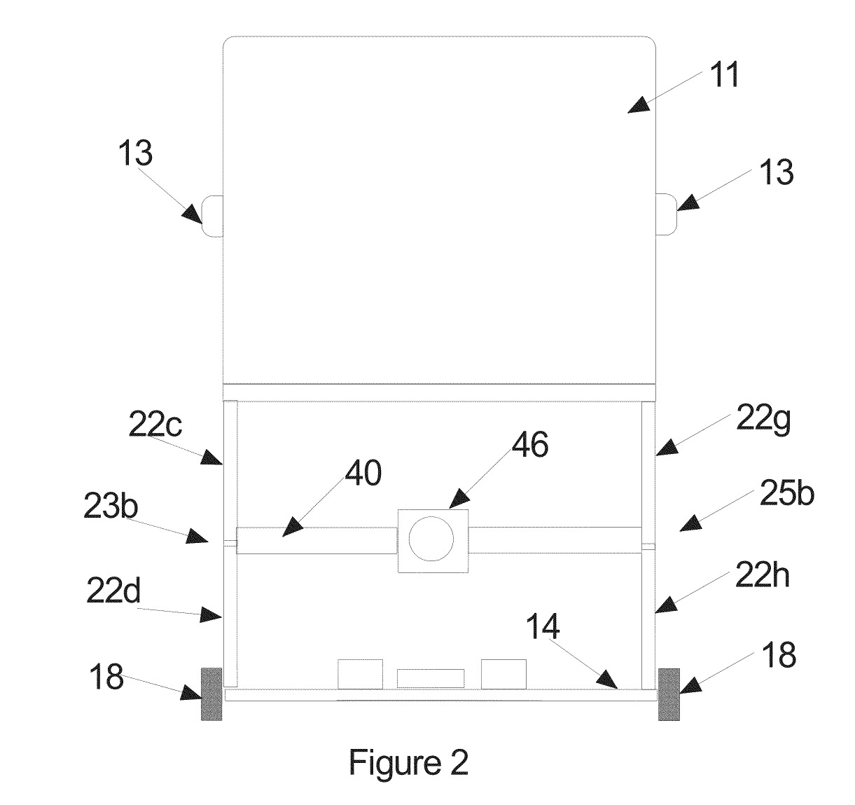

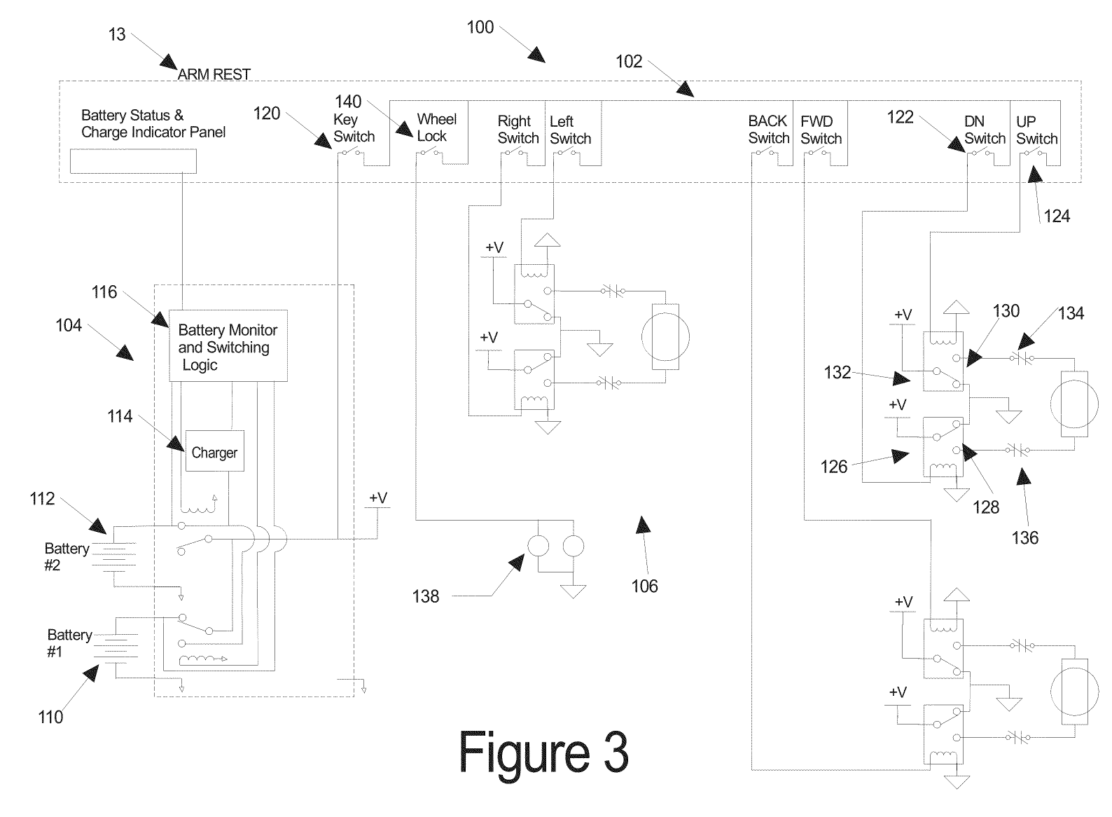

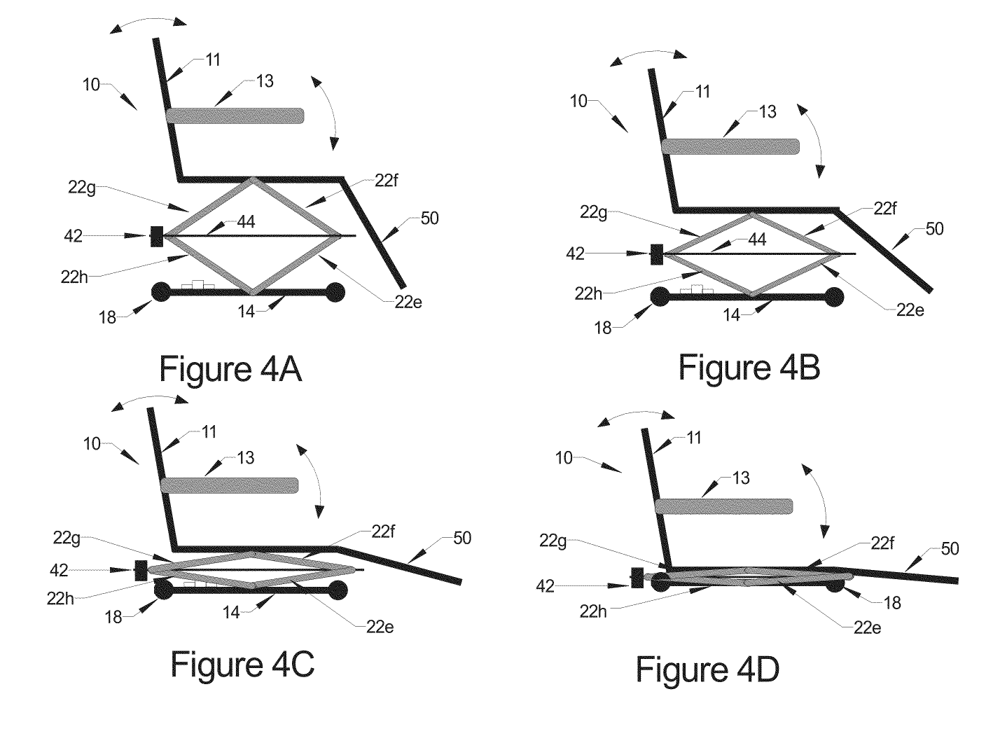

FIG. 1 illustrates an embodiment of the elevator chair 10 with a motor driven lift. The elevator chair 10, as illustrated in FIG. 1 is without its arm rests and a leg rest; examples of these are shown in FIGS. 4A-4D. The elevator chair 10 is also illustrated without the batteries and controls. Examples of these are illustrated in FIG. 2 and FIG. 3. As shown in FIG. 1, an elevator chair 10 has a seat 12 and a base or support 14 that rests on a surface of floor. A motor-driven lift 16 connects the seat 12 and the bottom or base 14. Manually guided controls 100 operate the lift 16. The lift 16 moves the seat 12 up and down between a sitting position or location above the base 14 to lower seat locations of an occupant's choosing, by operation of the controls 100, allowing the occupant to pick up or place an item on the floor or other work. When the occupant desires, the lift 16 moves the seat 12 upwardly to a sitting location, which can be the original sitting location. In the embodiment of FIG. 1, the lowest location for the seat 12 is at the floor (ranging between 4 to 8 inches from the floor).

As illustrated in FIG. 1 and FIGS. 4A-4B, the elevator chair 10 includes an upright back 11 that reclines. FIG. 4A and FIG. 4B illustrate the elevator chair 10 to include arm rests 13.

In another embodiment, an elevator chair can use a manually operated lift.

As shown in FIG. 1, the chair 10 has four rotatable mounted wheels 18 at each corner of the base 14. The wheels 18 can be motor driven and use a motor to steer the front wheel as explained below.

The base or support 14 is illustrated as being a solid sheet or panel. Other bases 14 can be used that are not panels. For example, one could use metal rails. The rails can be spaced apart and can be configured as a frame.

As shown, the motor-driven lift 16 is a scissor lift. The scissor lift has two sets of identical elongated scissor sets 20a and 20b, one on each opposite side of the chair 10. Set 20a includes four scissor arms 22a-22d. Arms 22a and 22b form a pair of front cooperating arms; arms 22c and 22d form a pair of form a pair of rear cooperating arms. Set 20b also includes four scissor arms, arms 22e -22h. Arms 22e and 22f form a pair of front cooperating arms; arms 22g and 22h form a pair of form a pair of rear cooperating arms.

Regarding the scissor set 20a, front scissor arms 22a and 22b pivotally joined to each other at one of their ends by a bolt 26 to form a front joint 23a. The lower end of arm 22a is pivotally joined to the base 14 on a base mount 24a and by a pin or bolt 26 (not shown). The upper end of arm 22b is pivotally joined to the seat 12 on a seat mount 24b and by a pin or bolt 26. The rear scissor arms 22c and 22d pivotally joined to each other at one of their ends by a pin or bolt 26 to form a joint 23b. The lower end of arm 22d is pivotally joined to the base 14 on a base mount 24a and by a pin or bolt 26 (not shown). The lower end of arm 22d is adjacent the lower end of arm 22a. The upper end of arms 22c is pivotally joined to the seat 12 on seat mount 24b and by a pin or bolt 26. The upper end of arm 22c is adjacent to the upper end of arm 22b.

Regarding scissor set 20b, the front arms 22e and 22f and the rear arms 22g and 22h are configured and pivotally mounted to the seat 12, the base 14 on base mount 24b, and to each other like the arms of scissor set 20a. The front scissor arms 22e and 22f pivotally join to each other form a front joint 25a. Where the rear scissor arms 22g and 22h pivotally join to each other form a rear joint 25b.

The outside surface of the upper ends of each pair of the scissor arms 22b, 22c and 22f, 22g (not shown) have meshing gears 29. The inside surface of the lower end of each pair of arm 22a, 22d (not shown) and 22e, 22h also have meshing gears 29. The meshing spur gears 29 provide stability to the lift 16.

As illustrated in FIG. 1 and FIG. 4A, the seat 12 is in the uppermost sitting position or location above the base 14. The scissor arms of both scissor sets 20a and 20b form a diamond in this sitting location.

FIG. 4B and FIG. 4C show the elevator chair 10 with the seat 12 at lower positions. FIG. 4D shows the elevator chair 10 with the seat 12 in its lowest position at the floor.

The motor-driven lift 16 includes a front elongated member 30 extending between front joints 23a and 25a to connect the two sides of lift 16. One end of the member 30 is connected for rotation at the front joint 23a; at the other end it is connected for rotation at the front joint 25a. Midway along the length of the member 30 there is a threaded wall passageway 32 extending through there.

The lift 16 also has a rear elongated mounting member 40 extending between rear joints 23b and 25b. This member 40 connects the two sides of lift 16. One end of the member 40 is connected for rotation at rear joint 23b; at the other end it is connected for rotation at rear joint 25b.

Mounted on the elongated member 40 is a reversible direction electric motor 42 with a drum switch. The motor 42 gets its electricity from an electrical source, such as a battery (not shown). As illustrated the motor 42 faces the front of the chair 10 and has a threaded shaft 44 extending in a direction toward the front of the chair 10. The shaft 44 extends through the passageway 32 where their threads mesh. The motor uses a gear box 46 to control its speed.

In operation, when the motor 40 rotates the threaded shaft 44 in one direction in the treaded passageway 32, the elongated members 30 and 40 are moved closer together. Consequently, the seat 12 rises. When the motor 40 rotates the shaft 44 in the opposite direction in the passageway 32, the elongated members 30 and 40 are moved further apart. Consequently, the seat 12 lowers.

As shown in FIGS. 4A-4D, the elevator chair 10 includes a leg rest 50 hinged to the front of the seat 12 or otherwise providing hinged movement between the seat 12 and the leg rest 50. The leg rest 50 is a rectangular shape panel or sheet in the embodiment of chair 10. The leg rest 50 supports the legs of a person sitting in the seat 12 throughout movement of the seat 12. The lower end of the leg rest 50 is near or on the floor and has rounded edge to help it move across the floor. The leg rest 50 is angled to the floor. As the seat 12 lowers, the lower end of the leg rest 50 moves across the floor further from the chair 10. As the seat 12 lowers, the leg rest 50 rises. Consequently, as the seat 12 lowers, the legs of a person sitting in the chair 10 are straightened without putting pressure on the person's knees.

The lower end of leg rest 50 could have rotatable mounted wheels or other help to aid movement of the leg rest 50 across the floor.

FIG. 3 is a schematic illustrating the controls 100 of the chair 10. The controls 100 include a control section 106 that controls the operation of the motor 42. The controls 100 also include a control panel 102. A power section 104 supplies the electrical power to the chair 10.

In the embodiment illustrated in FIG. 3, the control panel 102 is located on one of the arm rests, but the control panel 102 can be located elsewhere.

The power component 104 includes batteries 110 and 112, a charger 114, and a battery monitor and control logic 116. The charger 114 charges both batteries. One of the batteries is back-up for the other. The charger 114 plugs into a commercial electrical source, such a home electrical outlet (not shown). The unit 116 monitors the batteries and will automatically switch to the backup battery when needed and indicate the batteries need charged on the control panel. Battery switching could also be done manually on the control panel.

A person sitting in the chair 10 can control the movement of seat 12 by switches on the control panel 102. A switch 120 is an off/on key switch connected to the batteries 110 and 112 and other switches on the control panel 102 that control the motor 42. When the switch 120 is open, there is no electrical power is supplied to the chair 10. When the switch 120 is closed, electrical power is supplied to the chair 10. Switch 122 controls the downward movement of the seat 12. When the switch 122 is closed, a switch 128 of a relay 126 closes to supply electrical power to the motor 42. The motor 42 operates the lift 16 to lower the seat 12. The switch 124 controls the upward movement of the seat 12. When switch 124 is closed, a switch 130 of the relay 126 closes to supply electrical power to the motor 42. The motor 42 has power and it operates the lift 16 to raise the seat 12. Motors may be also included as shown in FIG. 3 to slowly move the rear wheels, providing a forward or backwards motion to the elevator chair and to control the front wheels to steer the elevator chair in a right or left direction. All or a subset of the wheels described herein can have manually or electronically activated wheel locks, for example, to keep the wheels from turning while the occupant of the chair raises and lowers the seat with the correspondent movement of the leg rest 50.

The controls 100 include an upper limit switch 134 and downward limit switch 136. The upward limit switch 134 stops the height of the sitting location of the seat 12 above the floor to a standard chair seat height. The downward limit switch 136 stops the seat 12 at the floor (approximately 4 to 8 inches above the floor).

A solenoid operated braking mechanism 138 applies pressure to the rear wheels by switch 114 to prevent the chair from moving while the occupant gets in or out of the chair.

It is understood that other types of lifts are useful for other embodiments of the elevator chair. For example, such lifts may include other types of scissor lifts or just one scissor lift having one set of cooperating scissor arms.

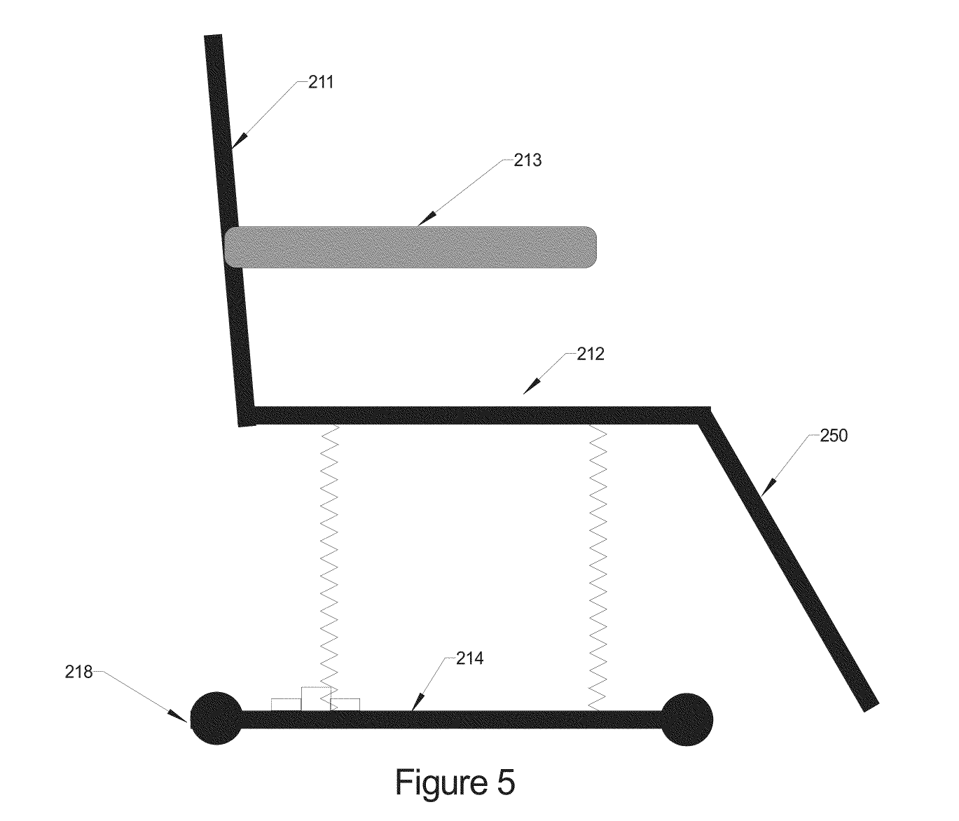

FIG. 5 illustrates a simple side elevation view of an embodiment of an elevator chair. FIG. 5 shows an elevator chair 200 with a pneumatic bellows lift 206. U.S. Pat. No. 4,538,854 discloses an example of a pneumatic lift, and is hereby incorporated herein. As illustrated, the elevator chair includes a seat 212, back 211, and arm and leg rests numbered 213 and 250 respectively. It also includes a base 214 and wheels 218. In another embodiment, the lift 206 could be hydraulic.

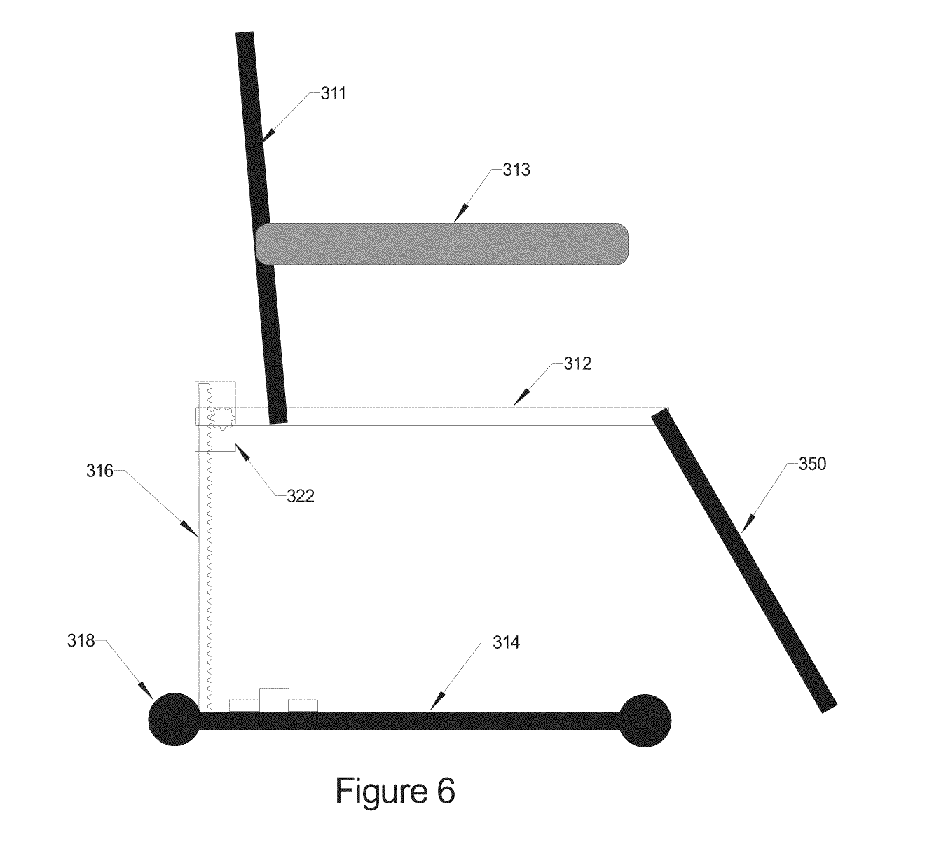

A simple side elevation view of another embodiment of an elevator chair is illustrated in FIG. 6. Such embodiment shows an elevator chair 300 with a rack and pinion lift 316 connecting a seat 312 and base 314. The lift 316 includes rack 320 and meshing pinion 322. A motor (not shown) drives the lift 316 to move the seat 312 up and down. The chair 300 includes a back 311, arm and leg rests numbered 313 and 350, respectively. The chair 300 has wheels 318 mounted on the base 314.

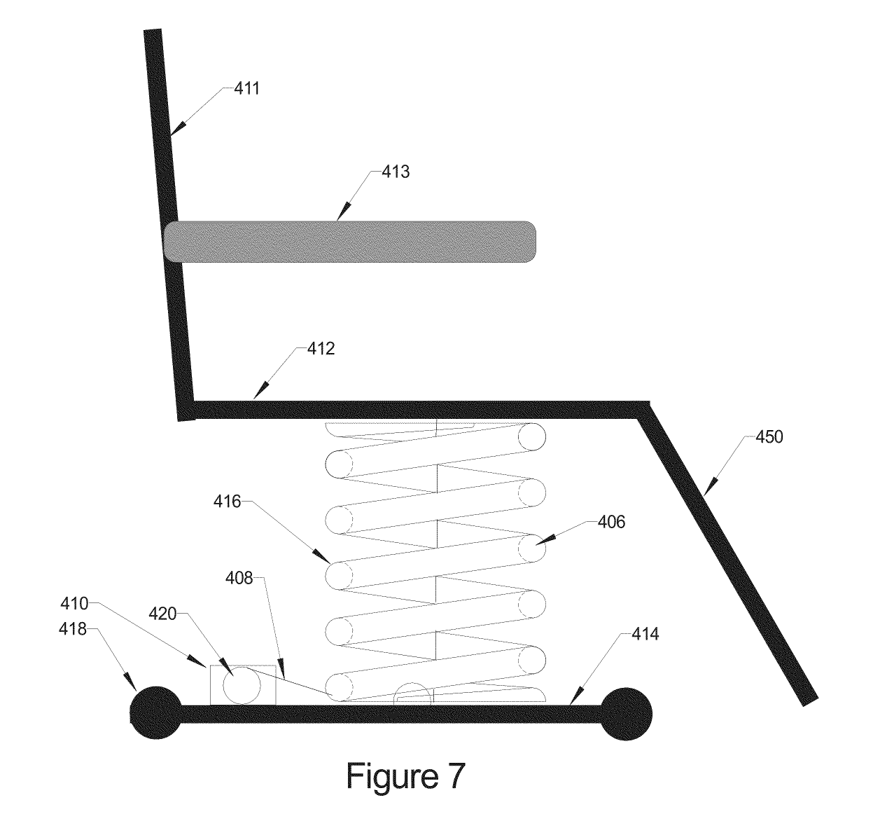

FIG. 7 illustrates a simple side elevation view of another embodiment of an elevator chair. FIG. 7 shows an elevator chair 400 with a spring lift 416 connecting a seat 412 and base 414. The chair 400 includes a back 411 and arm and leg rests 413 and 450, respectively. It also includes rotatable wheels 418 on the base 414. The lift 416 includes a spring 406, cable 408, and motorized capstan 410. The capstan 410 is mounted on the base 414 and includes a cylinder 420 and motor (not shown). One end of the cable 408 is attached to the underside of the seat 412 and the other end is wound around the cylinder 420 of the capstan 410. When the cylinder 420 rotates to wind the cable 408, the cable shortens and causes the seat 412 to be lowered. When the capstan 410 releases the cable 408, the upward force of the spring 406 raises the seat 412.

The elevator chair of invention has been described with a certain degree of particularity. But it is understood the disclosure has been made only by way of illustration. Changes in details of construction and arrangement of parts may be resorted to without deporting from the spirit and scope of the invention as set forth in the accompanying claims.

What is claimed is:

1. A chair comprising:
a seat with a sitting location above the floor;
a base that sits on a floor;
a lift connecting the seat and the base, the lift capable of moving the seat up and down from the sitting location to a lower location at the floor; and
a control system operating the lift, the control system allowing an occupant of the chair to move the seat between its sitting location and the lower location at the floor to enable the occupant to pick up or place an item on the floor while sitting in the chair and thereafter to move the seat upwardly.

2. The chair of claim 1 wherein the lift is a scissor lift.

3. The chair of claim 2, wherein the scissor lift includes a set of four cooperating scissor arms on opposite sides of the chair, each set including two front scissor arms pivotally joined to each other at one of their ends to form a front joint, the other end of the of one of the front scissor arms being pivotally connected to the seat, the other end of the other front scissor arms being pivotally connected to the base, each set including two rear scissor arms pivotally joined to each other at one of their ends to form a rear joint, the other end of the of one of the rear scissor arms being pivotally connected to the seat, the other end of the other rear scissor arms being pivotally connected to the base.

4. The chair of claim 3, wherein the scissor lift further includes a first elongated member with a threaded passageway opening there through, the elongated member pivotally mounted one end to the joint of one of the set of front cooperating scissor arms and pivotally mounted on the other end to the joint of the front of the other set of cooperating scissor arms, a second elongated member pivotally mounted at one end to the joint of one of the set of rear cooperating scissor arms and pivotally mounted on the other end to the joint of the rear of the other set of cooperating scissor arms, a motor mounted on the second elongated member between the two rear cooperating scissor arm, the motor having a threaded shaft extending through the threaded passageway with their threads meshing.

5. The chair of claim 4, wherein the controls enable an occupant in the chair to rotate the motor in both directions, one of the directions of the motor rotating the threaded shaft in the threaded passageway to move the first and second longitudinal members further apart lowering the seat to lower locations allowing the occupant to pick up or place on the floor an item of the floor while still seated.

6. The chair of claim 1, wherein the lower location is approximately between 4 and 8 inches above the floor.

7. A chair comprising:
a seat;
a base that sits on a floor; and
a lift connecting the seat and the base being effective to move the seat back forth only between locations from a sitting location above the base and to locations lower than the sitting location, a lowest of the lower locations being at the floor.

8. The chair of claim 7 where the lift is a scissor lift.

9. The chair of claim 8, further comprising a leg rest moveably connected to a front of the seat, the leg rest rising when the seat is lowered and lowering when the seat is raised.

10. An elevator chair comprising:
a seat with an upright back;
a support that rests on a floor; and
a lift connecting the seat to the support, the lift being adapted to move the seat up and down with respect to the floor between a sitting location above the floor and a lower location within approximately eight inches of the floor.

11. The elevator chair of claim 10, further comprising wheels coupled to the support.

12. The elevator chair of claim 11, wherein one or more of the wheels are motorized.

13. The elevator chair of claim 10, wherein the lift is motorized.

14. The elevator chair of claim 10, further comprising a control system operating the lift, the control system allowing an occupant of the chair to move the seat between the sitting location and the lower location at the floor to enable the occupant to pick up or place an item on the floor while sitting in the chair and thereafter to move the seat upwardly.

15. The elevator chair of claim 10, further comprising a leg rest moveably connected to a front of the seat, the leg rest automatically rising when the seat is lowered and automatically lowering when the seat is raised.
